(19) United States
(12) Patent Application Publication
(10) Pub. No.: US 2010/0009127 A1
(43) Pub. Date: Jan. 14, 2010

(54) METHOD FOR FORMING A MICRO PATTERN USING A TRANSFER TECHNIQUE

(76) Inventor: EIJI KARIYADA, Tokyo (JP)

Correspondence Address: Mr. Jackson Chen, 6535 N. STATE HWY 161, IRVING, TX, 75039, US

(21) Appl. No.: 12/498,144

(22) Filed: Jul. 6, 2009

(30) Foreign Application Priority Data
Jul. 10, 2008 (JP) 2008-180534

(51) Int. Cl. B32B 3/30; B29C 35/08

(52) U.S. Cl. 428/187; 264/494

(57) ABSTRACT

A pattern transfer method includes: forming a dielectric film on a first substrate on which a concavo-convex pattern is formed; coupling together the first substrate and a second substrate with an intervention of the dielectric film, a fluorine-containing UV-ray-cured resin and a fluorine-free UV-ray-cured resin which are arranged in this order from the first substrate to the second substrate; separating the first substrate from the second substrate at an interface between the dielectric film and the to fluorine-containing UV-ray-cured resin, to transfer the concavo-convex pattern onto the fluorine-containing UV-ray-cured resin.

This application is based upon and claims the benefit of priority from Japanese patent application No. 2008-180534 filed on Jul. 10, 2008, the disclosure of which is incorporated herein in its entirety by reference.

### FIELD OF THE INVENTION

The present invention relates to a method for forming a micro pattern using a transfer technique and, more particularly, to a method for transferring a concavo-convex pattern formed on a substrate to another substrate by using a transfer technique. The present invention also relates to a structure having such a concavo-concave pattern formed by using such a method.

### BACKGROUND ART

Along with a rapid development of digital information technology, it has been desired for an optical disc representing current storage devices to have a larger capacity. For achieving the larger capacity for the optical disc, intensive efforts have been provided in a variety of fields relating to the optical disc. A 120-mm-diameter optical disk, for example, that is currently on the market has a storage capacity of about 15-30 GB (gigabyte) with a pit length of 0.1-0.2 μm. For achieving the next-generation and subsequent-generation optical disks, it is now investigated to reduce the minimum pit length (shortest pit length) for a further increased storage capacity.

For manufacturing optical disks having a reduced minimum pit length, it is ordinary to use a master disk that is manufactured using a deep ultra-violet (UV) laser ray or an electron beam. Examples of the minimum pit length include as small a pit length as 80 nm in the case of using the deep UV laser ray, and 40 nm in the case of using the electron beam. If the minimum pit length is 40 nm, a storage capacity of about 500 GB/12 cm is expected. The optical disk used for such a higher density recording/reproducing is manufactured from a stamper, to which a copy pattern is transferred from the master disk, by using an injection mold technique.

A technique for forming a stamper or a plurality of substrates copied from the master disk is described in Patent Publications-1 and -2. These publications use a technique of forming the stamper by copying the concavo-convex pattern from the master disk while using UV-ray-cured resin, and forming a plurality of substrates from the stamper.

The technique of Patent Publication-1 will be described hereinafter. The master disk has thereon a concavo-convex pattern obtained by forming a guide groove and/or data pits on the surface of a photosensitive resin. The master disk having an original concavo-convex pattern or the stamper having a pattern inverted from the original concavo-convex pattern is provided with a teflon (registered trademark) film as a releasing layer, onto which a UV-ray-cured resin is applied for coating. The resultant master disk or stamper is then bonded onto another substrate member. After irradiating UV-rays onto the UV-ray-cured resin, the master disk or stamper is separated from the another substrate member at the interface between the teflon film and the UV-ray-cured resin, thereby transferring the concavo-convex pattern including the guide groove or data pits onto the another substrate member.

Formation of the micro pattern described in Patent Publication-2 will be described. A thin oxide film is formed on the surface of master disk or stamper, and a fluorine-containing compound film is formed thereon by coating or evaporation. Thereafter, a heat treatment is performed for enhancing the adhesive strength between the thin oxide film and the fluorine-containing compound film. The heat treatment reduces the surface energy of concavo-convex surface of the master disk or stamper, thereby improving the releasability at the interface between the UV-ray-cured resin and the fluorine-containing compound film.

Parallel to the efforts provided for achieving the large-capacity optical disk, another effort is also provided for obtaining a larger capacity for a cartridge that receives therein a plurality of optical disks. In order for increasing the number of optical disks received in a single cartridge to remarkably increase the storage capacity per cartridge, it is needed to allow the optical disks to have as small a thickness as possible. Thus, an effort for development of an optical disk having a thickness as small as 100 μm is being provided.

A “patterned medium” is also on the development that is a candidate HDD (hard disk drive) having a storage density ten times as large as the storage density, 100-Gbit/inch², of the current HDD. In order to obtain such a storage density of terabit (Tbit)/inch², it is desired to reduce the dot pitch down to 25 nm or smaller, and to arrange the dots in an array on a circumferential direction. For achieving this configuration, a technique is developed that forms a concavo-convex pattern on an aluminum (Al) film formed on a magnetic disk substrate, the concavo-convex pattern being similar to the land/mark pattern formed on the optical disk. The concavo-convex pattern is then subjected to anodic oxidation to obtain a regular arrangement of a plurality of micro dots only within the groove.

In the above description, formation of the micro pattern on the recording medium (storage device) is exemplified. However, the media that are desired to have a larger storage capacity are not limited to the recording media. For example, a semiconductor element such as TFT (thin film transistor) is developed that has a reduced gate length or reduced source/drain regions for achieving a higher integration density or smaller power dissipation.

In order to achieve a higher recording density of the HDD medium or reduced gate length etc. of the semiconductor element, the technique for reduction in the dimension of mask pattern on the master disk or photomask is important. The reduction in the dimension of mask pattern may be achieved using exposure of the pattern to the deep UV-ray or electron beam. In the current technique for manufacturing the micro devices, transferring of the micro pattern as well as formation of the micro pattern is the key technology.

It is to be noted that an optical waveguide representing optical communication devices generally uses a micron-order or submicron-order micro pattern unlike the nanometer-order micro pattern as discussed above. The process for forming the optical waveguide includes manufacture of a wafer including therein a buried polymer optical waveguide. The optical waveguide is manufactured by forming a master disk having a desired shape of the optical waveguide, and thereafter forming the micro pattern on a silicon (Si) wafer.

### Related Art Documents Include:

Patent Publication-1, JP-1989-107338A; and

Patent Publication-2, JP-1994-103617A.

As described before, it is desired to reduce the thickness of the optical disks in order for increasing the number of optical disks that can be received in a cartridge and drastically increasing the storage capacity, and for this purpose an extremely thin substrate having a thickness of around 100 μm is increasingly used. A polycarbonate (PC) substrate generally used for a compact disk (CD) or digital versatile disk (DVD) has a thickness of 0.6 to 1.2 mm. The transferring of concavo-convex pattern to this PC disk has been performed using the injection mold technique without a problem. However, formation of the extremely thin substrate having a thickness of around 100 μm by using the injection mold technique requires accurate control of the minute amount of filled resin. More specifically, it is generally difficult to control the minute amount of filled resin, and thus difficult to mold the film-like substrate having a thickness of about 100 μm with a superior reproducibility.

The pattern transfer described in Patent Publication-1 uses a teflon film as the releasing assist film. This pattern transfer is involved with the problem that the process of pattern transfer for a plurality of times causes release of a part of the teflon film from the surface of master disk or stamper and attachment to the substrate member that is the target for transferring. This is caused by an external force exerted onto the interface between the teflon film and the master disk or stamper. Release of a part of the teflon film generates a defect on the transferred pattern, and impedes a smooth release using the teflon film after the transferring.

The pattern transfer described in Patent Publication-2 performs the film separation at the interface between the fluorine-containing compound film formed on the master disk or the stamper and the UV-ray-cured resin film to which the pattern is transferred, with an intervention of the thin oxide film. This necessitates a larger adhesive strength between the fluorine-containing compound film and the underlying thin oxide film. In addition, the UV-ray-cured resin film used for the pattern transfer must have a higher adhesive strength with respect to the substrate to which the pattern is transferred. This necessitates a heat treatment after the process of forming the thin oxide film on the master disk or stamper and subsequent dropping application or evaporation of the fluorine-containing compound film. The enhancement of the adhesive strength between the UV-ray-cured resin film for pattern transfer and the substrate to which the pattern is transferred generally requires an adhesion assist agent, and thus complicates the process.

In the technique of Patent Publication-2, an accurate transfer of the concavo-convex pattern formed on the master disk or stamper can be achieved by an accurate control of the thickness of the extremely thin fluorine-containing compound film that is formed to reduce the surface energy. However, the fact that the fluorine-containing compound does not have a significant sensitivity to UV rays necessitates performing a heat treatment after the dropping application and thus complicates the process, or necessitates employment of an evaporation process which makes it difficult to control the thickness. The heat treatment performed at a high temperature of around 100° C. for improving the adhesive strength between the thin oxide film and the fluorine-containing compound film requires that the master disk or stamper have a heat resistance at 100° C. Thus, another problem arises that an organic resin such as PC having a lower glass transition point cannot be used for the master disc or stamper. Further, such a heat treatment may cause that the extremely thin film substrate having a thickness of around 100 μm is reacted with the adhesion assist agent to be deformed or contracted.

The problems as to the transfer process of the micro pattern are not limited to the optical disc, and are common to the process of pattern transfer that is performed for increasing the storage density of the HDD media and for reducing the gate length etc. of the semiconductor device.

### SUMMARY OF THE INVENTION

It is an object of the present invention to provide a process for forming a micro pattern that is capable of performing an accurate pattern transfer from a substrate, such as the master disk or stamper, to another substrate. It is another object of the present invention to provide a structure manufactured by the above process.

The present invention provides a method including: forming a dielectric film on at least one of surfaces of a first substrate on which a concavo-convex pattern is formed; coupling together the first substrate and a second substrate with an intervention of the dielectric film, a fluorine-containing ultraviolet (UV)-ray-cured resin and a fluorine-free UV-ray-cured resin which are arranged in this order from the first substrate to the second substrate; and separating the first substrate from the second substrate at an interface between the dielectric film and the fluorine-containing UV-ray-cured resin, to transfer the concavo-convex pattern onto the fluorine-containing UV-ray-cured resin.

The present invention provides a structure having thereon the micro pattern formed by using the method according to the present invention.

The above and other objects, features and advantages of the present invention will be more apparent from the following description, referring to the accompanying drawings.

### BRIEF DESCRIPTION OF THE DRAWINGS

FIG. 1 is a sectional view showing a step of a pattern transfer process according to an exemplary embodiment of the present invention.

FIGS. 2A to 2D are sectional views showing consecutive steps of the pattern transfer process of the first example of the present invention.

FIG. 3 is a sectional view showing a step of a pattern transfer process of a comparative example.

FIGS. 4A to 4D are sectional views showing consecutive steps of a pattern transfer process according to a second example of the present invention.

FIGS. 5A to 5D are sectional views showing consecutive steps of a pattern transfer process according to a third example of the present invention.

FIGS. 6A to 6D are sectional views showing consecutive steps of a pattern transfer process according to a fourth example of the present invention.

FIGS. 7A to 7D are sectional views showing consecutive steps of a pattern transfer process according to a fifth example of the present invention.

### EXEMPLARY EMBODIMENT

Now, an exemplary embodiment and examples of the present invention will be described with reference to accompanying drawings, wherein similar constituent elements are designated by similar reference numerals throughout the drawings.

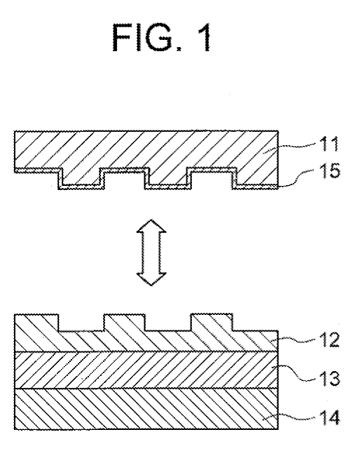

FIG. 1 shows a step of a pattern transfer process according to an exemplary embodiment of the present invention. A first substrate 11 mounts a micro concavo-convex pattern formed at least one of the surfaces thereof. A dielectric film 15 having a specific thickness is formed on the first substrate 11 having the concavo-convex pattern. The material for the dielectric film includes at least one material selected from the group consisting of an oxide, a nitride and an oxynitride. For example, the dielectric film 15 is made of SiON having a thickness of 20 nm.

The first substrate 11 is a starting substrate from which the micro concavo-convex pattern is first transferred to another (second) substrate or other substrates, and thus serves as a model substrate. The first substrate 11 may be a molded nickel (Ni) substrate including Ni as a main component thereof, or a molded SiO₂ substrate including SiO₂ as a main component thereof. In an alternative, the first substrate 11 may be a polycarbonate (PC) substrate having a thickness of around 0.6 to 1.5 mm, which is one of a plurality of copy substrates manufactured by an injection mold technique using the molded Ni. It is assumed herein that the first substrate 11 is a 1.2-mm-thick PC substrate.

The second substrate 14 is a transfer-target substrate to which the micro concavo-convex pattern formed on the first substrate 11 is transferred. The transfer-target substrate 14 is typically a PC substrate or glass substrate if the micro pattern is used for an optical element. The transfer-target substrate 14 may be a silicon (Si) substrate if the micro pattern is used as a member of a semiconductor device.

The first substrate 11 and transfer-target substrate 14 are coupled together with an intervention of the dielectric film 15, a fluorine-containing UV-ray-cured resin 12 and a fluorine-free UV-ray-cured resin 13, which are consecutively arranged from the first substrate 11 to the transfer-target substrate 14. Thereafter, the first substrate 11 and second substrate 14 are separated from each other at the interface between the dielectric film 15 and the fluorine-containing UV-cured resin film 12. This process allows the concavo-convex pattern formed on the first substrate 11 to be transferred to the surface of the fluorine-containing UV-ray-cured resin 12 that is formed on the transfer-target substrate 14.

After the coupling of the first substrate 11 and transfer-target substrate 14, UV rays are irradiated onto both the fluorine-containing UV-ray-cured resin 12 and fluorine-free UV-ray-cured resin 13 for curing and adhesion (bonding) thereof. One of the fluorine-containing UV-ray-cured resin 12 and fluorine-free UV-ray-cured resin 13 is preliminarily cured before the coupling. In the preliminary curing before the coupling, the fluorine-containing UV-ray-cured resin 12, for example, is preliminarily cured, and both the fluorine-containing UV-ray-cured resin 12 and fluorine-free UV-ray-cured resin 13 are irradiated with UV rays after the coupling of the first substrate 11 and transfer-target substrate 14. In an alternative, the fluorine-free UV-ray-cured resin 13 may be preliminarily cured before the coupling, followed by coupling of both the substrates 11 and 14 and subsequent curing of both the fluorine-containing UV-ray-cured resin 12 and fluorine-free UV-ray-cured resin 13.

The reason for performing the preliminary curing is as follows. Some of the UV-ray-cured resins are not completely cured in the atmosphere, an oxygen-containing ambient in particular, depending on the material of the UV-ray-cured resin even if UV rays are irradiated onto the surface thereof. In this case, the UV-ray-cured resin may be cured only in the vicinity of the surface thereof near the second substrate 14 or the surface not exposed to the oxygen-containing ambient. More specifically, the surface of the UV-ray-cured resin exposed to the oxygen-containing ambient is not completely cured. The term “preliminary curing” as used in this text means an insufficient curing of the UV-ray-cured resin, such as caused in the case of oxygen-containing ambient. The UV-ray-cured resin that is subjected to the preliminary curing is completely cured thereafter during irradiation of UV rays after the coupling of the first substrate and second substrate, due to interruption of oxygen from the oxygen-containing ambient. The UV rays irradiated after the coupling of both the substrates completely cures both the UV-ray-cured resins 12 and 13 and advances adhesion of both the UV-ray-cured resins 12 and 13 at the interface thereof. The UV rays may be irradiated from the first substrate 11 and/or second substrate 14.

The coupling of both the substrates 11 and 14 may be performed in one of the following four processes. The first process is such that the fluorine-containing UV-ray-cured resin 12 is applied for coating onto the dielectric film 15 on the first substrate 11, and subjected to the preliminary curing using UV rays that irradiate the entire surface of the fluorine-containing UV-ray-cured resin 12. Subsequently, the fluorine-free UV-ray-cured resin 13 is applied for coating onto the transfer-target substrate 14. Thereafter, the first substrate 11 and transfer-target substrate 14 are coupled together so that the fluorine-containing UV-ray-cured resin 12 and the UV-ray-cured resin 13 are in contact with each other, and pressed against each other for bonding. UV rays are irradiated thereafter from the outside through the first substrate 10 and/or second substrate 11, thereby completely curing and adhering together both the UV-ray-cured resins 12 and 13.

The second process is such that the fluorine-containing UV-ray-cured resin 12 is applied for coating onto the dielectric film 15 on the first substrate 11, and subjected to the preliminary curing using UV rays that irradiate the entire surface of the UV-ray-cured resin 12. The fluorine-free UV-ray-cured resin 13 is then applied for coating onto the fluorine-containing UV-ray-cured resin 12. Thereafter, the first substrate 11 and second substrate 14 are coupled together so that the surface of the fluorine-free UV-ray-cured resin 13 is in contract with the second substrate 14, and pressed against each other. After the coupling of both the substrates 11 and 14, UV rays are irradiated through the first substrate 11 and/or second substrate 14 for curing and bonding together both the fluorine-containing UV-ray-cured resin 12 and fluorine-free UV-ray-cured resin 13.

The third process is such that the fluorine-free UV-ray-cured resin 13 is applied for coating onto the transfer-target substrate 14, followed by preliminary curing of the fluorine-free UV-ray-cured resin 13 while using UV rays that irradiate the entire area of the fluorine-free UV-ray-cured resin 13. Subsequently, the fluorine-containing UV-ray-cured resin 12 is applied for coating onto the dielectric film 15 on the first substrate 11. Thereafter, both the substrates 11 and 14 are coupled together so that the fluorine-containing UV-ray-cured resin 12 and fluorine-free UV-ray-cured resin 13 are in contact with each other, and pressed against each other. After the coupling of both the substrates 11 and 14, UV rays are irradiated onto the fluorine-containing UV-ray-cured resin 12 and fluorine-free UV-ray-cured resin 13 for curing and adhesion.

The fourth process is such that the fluorine-free UV-ray-cured resin 13 is applied for coating onto the transfer-target substrate 14, and subjected to the preliminary curing. The fluorine-containing UV-ray-cured resin 12 is then applied for coating onto the fluorine-free UV-ray-cured resin 13. Subsequently, the first substrate 11 and second substrate 14 are coupled together so that the surface of fluorine-containing UV-ray-cured resin 12 and the first substrate 11 are in contact with each other, and pressed against each other. Thereafter, UV rays are irradiated through the first substrate and/or second substrate 14 onto both the fluorine-containing UV-ray-cured resin 12 and fluorine-free UV-ray-cured resin 13 for curing and adhesion.

The dielectric film 15 is provided in order to assist smooth separation between the first substrate 11 and the fluorine-containing UV-ray-cured resin 12 after transferring the micro concavo-convex pattern from the first substrate 11 onto the surface of the fluorine-containing UV-ray-cured resin 12. If the first substrate 11 is a PC substrate, the dielectric film having a function of preventing reaction between a monomer component in the fluorine-containing UV-ray-cured resin 12 and the PC substrate. In this case, if the dielectric film is not provided so that the PC substrate and the fluorine-containing UV-ray-cured resin 12 are in direct contact with each other, the reaction between the monomer component in the fluorine-containing UV-ray-cured resin 12 and the PC substrate causes melting of the surface of the PC substrate, whereby it is difficult to smoothly separate the first substrate 11 from the fluorine-containing UV-ray-cured resin 12.

The fluorine-containing UV-ray-cured resin 12 has a weak adhesive strength with respect to the surface of a glass substrate or Si substrate used as the transfer-target substrate 14. For improvement of this adhesive strength, the fluorine-free UV-ray-cured resin 13 is formed as the intervening layer between the transfer-target substrate 14 and the fluorine-containing UV-ray-cured resin 12 to which the pattern is transferred. The fluorine-free UV-ray-cured resin 13 provided between the fluorine-containing UV-ray-cured resin 12 and the transfer-target substrate 14 improves the adhesive characteristic of the fluorine-containing UV-ray-cured resin 12. If the transfer-target substrate 14 is a PC substrate, the fluorine-free UV-ray-cured resin 13 has a function of preventing reaction between the PC substrate and the monomer component in the fluorine-containing UV-ray-cured resin 12.

The process of the present embodiment includes the steps of forming the dielectric film 15 on the surface of first substrate 11 having thereon a concavo-convex pattern, coupling together the first substrate 11 and the transfer-target substrate 14 to which the pattern is to be transferred with an intervention of the dielectric film 15, fluorine-containing UV-ray-cured resin 12 and fluorine-free UV-ray-cured resin 13 that are consecutively arranged from the first substrate 11 to the transfer-target substrate 14, and separating the first substrate 11 from the transfer-target substrate 14 at the interface between the dielectric film 15 and the fluorine-containing UV-ray-cured resin 12. In this configuration, the dielectric film 15 having a superior releasability and inserted between the fluorine-containing UV-ray-cured resin 12 and the first substrate enables smooth release of the transfer-target substrate 14 from the first substrate 11. In addition, the fluorine-free UV-ray-cured resin 13 having a superior adhesive strength with respect to both the fluorine-containing UV-ray-cured resin 12 and transfer-target substrate 14 and provided therebetween improves the adhesive strength between the fluorine-containing UV-ray-cured resin 12 and the transfer-target substrate 14 to which the pattern is transferred. Thus, the micro pattern having a concavo-convex shape and formed on the first substrate 11 is transferred to the other substrate substantially without a problem by the process of the present embodiment.

Use of the PC substrate manufactured by reproduction (or copy) using an injection mold technique that uses a molded Ni as the first substrate 11 having the micro concavo-convex pattern thereon allows easy replacement of the PC substrate by another PC substrate. The replacement can be performed at any time when the PC substrate is damaged by a trouble of the process etc. Even if the PC substrate goes out of stack, the molded Ni substrate stored can be used again for reproduction of a large number of PC substrates. Thus, use of the PC substrate as the first substrate, instead of direct use of the molded Ni substrate for the pattern transfer, increases the lifetime of the molded Ni substrate and reduces the to manufacturing cost.

The method for forming the micro pattern according to the present embodiment can be used for manufacture of the structure, such as an optical disk substrate, a magnetic-disk substrate, a photomask, having thereon a micro pattern.

Examples of the process according to the present embodiment will be described hereinafter. A first example used a molded PC substrate that was mass-produced from a Ni stamper by using an injection mold technique. The molded PC substrate had a thickness of 1.2 mm, and included a micro concavo-convex pattern formed on one of the surfaces thereof. A 100-μm-thick PC film (substrate) was used as the transfer-target substrate 14. In the first example, the micro pattern formed on the molded PC substrate was transferred to the PC film.

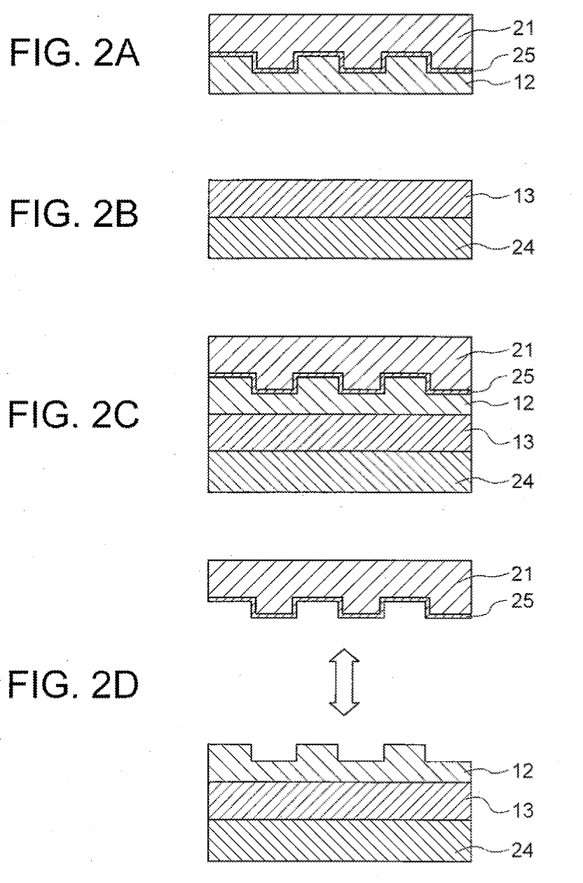

FIGS. 2A to 2D are sectional views showing consecutive steps of the process of the first example. A SiON film 25 was formed to a thickness of 20 nm on the molded PC substrate 12 on which the micro concavo-convex pattern had been formed. Subsequently, the fluorine-containing UV-ray-cured resin 12 was applied for coating onto the SiON film 25, followed by preliminary curing of the fluorine-containing UV-ray-cured resin 12 by using UV rays to obtain the structure shown in FIG. 2A. The fluorine-containing UV-ray-cured resin 12 was a photosensitive-cured resin that included: 25 wt % fluorine-containing monomers; 35 wt % tetraethylene-glycol-diacrylate; 35 wt % 2-methyl 2-adamanthyl acrylate; 1 wt % surfactant; and 4 wt % photopolymerization initiator.

In the mean time, the fluorine-free UV-ray-cured resin 13 was applied for coating onto the 100-μm-thick PC film 24 as shown in FIG. 2B. The fluorine-free UV-ray-cured resin 13 used here was a UV-ray-cured resin including acrylic ester as the main component thereof. Subsequently, the molded PC substrate 21 and the PC film 24 were coupled and bonded together so that the surface of fluorine-containing UV-ray-cured resin 12 that was preliminarily cured and the surface of fluorine-free UV-ray-cured resin 13 were in contact with each other. In this state, UV rays were irradiated from the outside onto the fluorine-containing UV-ray-cured resin 12 and fluorine-free UV-ray-cured resin 13 for curing and bonding, as shown in FIG. 2C. The curing of the fluorine-containing UV-ray-cured resin 12 and fluorine-free UV-ray-cured resin 13 allows the molded PC substrate 21 and PC film 24 to be bonded together with an intervention of the SiON film 25, fluorine-containing UV-ray-cured resin 12 and fluorine-free UV-ray-cured resin 13 which are arranged in this order from the molded PC substrate 21.

After coupling together the molded PC substrate 21 and PC film 24, the molded PC substrate 21 is separated from the PC film 24 at the interface between the SiON film 25 and the fluorine-containing UV-ray-cured resin 12, as shown in FIG. 2D. Separation of the molded PC substrate 21 from the PC film 24 allowed the fluorine-containing UV-ray-cured resin 12 to have an exposed surface having an inverted pattern obtained by inverting the concavo-convex pattern formed on the molded PC substrate 21. The molded PC substrate 21 was then used to transfer the micro pattern to another PC film 24.

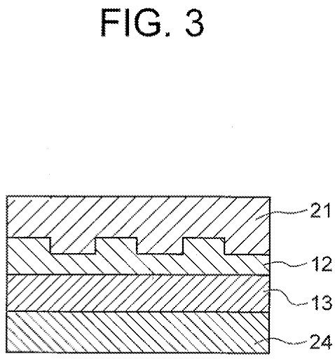

For the purpose of comparison with the first example, a method of first comparative example was used wherein the SiON film 25 shown in FIGS. 2A to 2D was not provided on the molded PC substrate 21. FIG. 3 shows a step of the first comparative example before the separation. The fluorine-containing UV-ray-cured resin 12 was applied to directly coat the molded PC substrate 21 having thereon the micro concavo-convex pattern, followed by irradiation of UV rays onto the fluorine-containing UV-ray-cured resin 12 for preliminary curing thereof. After applying the fluorine-free UV-ray-cured resin 13 for coating onto a 100-μm-thick PC film 24, the resultant PC film 24 was coupled to the molded PC substrate 21 so that the fluorine-containing UV-ray-cured resin 12 and fluorine-free UV-ray-cured resin 13 were in contact with each other, as shown in FIG. 3.

In the state shown in FIG. 3, UV rays are irradiated onto the fluorine-containing UV-ray-cured resin 12 and fluorine-free UV-ray-cured resin 13 for curing and bonding, whereby the fluorine-free UV-ray-cured resin 13 was strongly bonded to both the fluorine-containing UV-ray-cured resin 12 and PC film 24. On the other hand, the molded PC substrate 21 strongly reacted with the fluorine-containing UV-ray-cured resin 12 at the surface portion of the substrate 21 and strongly bonded onto the fluorine-containing UV-ray-cured resin 12. The strong adhesion between the molded PC substrate 21 and the PC film 24 via the two types of UV-ray-cured resins rendered difficult the separation between the molded PC substrate 21 and the PC film 24.

The inventor conducted an experimental process that included the steps of forming a plurality of samples having different thicknesses of the dielectric (SiON) film 15 formed on the first substrate 21 including the micro pattern, transferring the micro pattern onto the transfer-target substrate 14 by using the above process, judging the releasability after the transfer of the micro pattern, and observing the surface of the SiON film by using an AFM (atomic force microscope). Table 1 shows the results of judgment and observation for each sample.

TABLE 1

| Sample: | | |
|---|---|---|
| Thickness (nm) of | | Results of |
| SiON | Releasability | Observation |
| 1 | NG | Not observed |
| 3 | G | Without defect |
| 5 | G | Without defect |
| 10 | G | Without defect |
| 20 | G | Without detect |
| 25 | G | Without defect |
| 28 | G | Without defect |
| 30 | G | Presence of Crack |
| 50 | G | Presence of Crack |

The sample having a thickness of 1 mm experienced that both the substrates were not separated and thus the surface of the SiON film could not be observed.

The conclusion obtained from analysis of the results of the experimental process is as follows. If the thickness of the SiON film is smaller than 3 nm, the SiON film has therein pinholes inherent to the thin film. These pinholes pass a part of the fluorine-containing UV-ray-cured resin 12 through the SiON film, whereby the passed fluorine-containing UV-ray-cured resin 12 reacts with the surface of the PC substrate used as the first substrate 11. Thus, separation between the substrates was not possible after the transfer of micro pattern. On the other hand, if the thickness of the SiON film is above 3 nm, the SiON film does not have pinholes therein whereby the separation between the substrates after the pattern transfer was performed without a problem.

Upon separation between the substrates, the SiON film formed on the PC substrate is subjected to the repeated stress from the outside. If the SiON has a thickness larger than 30 nm, the repeated stress applied upon the separation damages the SiON film to generate therein a crack. The crack generated in the SiON film reduces the adhesive strength of the SiON film with respect to the first substrate 11, whereby the SiON film adheres onto the fluorine-containing UV-ray-cured resin 12 and impedes the desired separation between the substrates. In short, the thickness of the SiON film is preferably between 3 nm and 28 nm, and more preferably between 5 nm and 25 nm.

Next, a second example will be described. The second example used, as the first substrate, a molded silica glass, referred to as molded SiO₂ hereinafter. The molded SiO₂ has thereon a micro concavo-convex pattern formed using a direct lithographic technique. A SiN film was used as the dielectric film. A 1-mm-thick Si substrate was used as the transfer-target substrate. In this example, the micro pattern formed on the molded SiO₂ was transferred to the Si substrate.

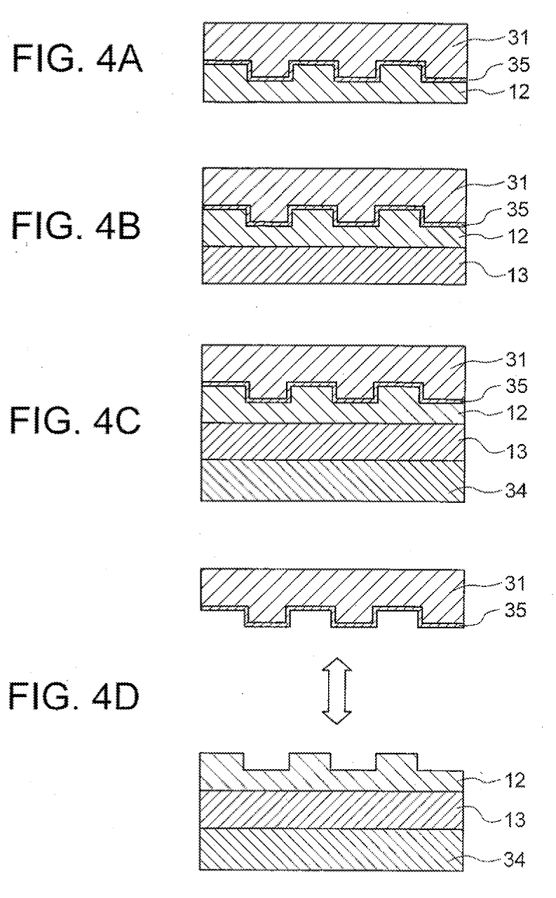

FIGS. 4A to 4D show consecutive steps of the process of the second example. The first substrate was a 10-mm-thick molded SiO₂ 31 having a micro concavo-convex pattern on one of the surfaces of the molded SiO₂ 31. A 20-nm-thick SiN film 35 was formed on the surface of concavo-convex pattern on the molded SiO₂ by using a sputtering technique. The fluorine-containing UV-ray-cured resin 12 was applied for coating onto the surface of the SiN film 35, followed by irradiation of UV rays from the outside for preliminary curing of the fluorine-containing UV-ray-cured resin 12 to obtain the structure shown in FIG. 4A. The fluorine-containing UV-ray-cured resin 12 was a photosensitive-cured resin similar to that used in the first example.

Thereafter, the fluorine-free UV-ray-cured resin 13 was applied for coating onto the fluorine-containing UV-ray-cured resin 12 subjected to the preliminary curing, to obtain the structure shown in FIG. 4B. A photosensitive-cured resin similar to that used for the fluorine-free UV-ray-cured resin 13 in the first example was used as the fluorine-free UV-ray-cured resin 13 in this example. Subsequently, the molded SiO₂ 31 and Si substrate 34 were coupled and bonded together so that the fluorine-free UV-ray-cured resin 13 and the surface of Si substrate 34 were in contact with each other. In this state, UV rays were irradiated from the outside through the molded SiO₂ 31 to cure and bond together the fluorine-containing UV-ray-cured resin 12 and fluorine-free UV-ray-cured resin 13, as shown in FIG. 4C.

After coupling together the molded SiO₂ 31 and Si substrate 34, the molded SiO₂ 31 was separated from the Si substrate 34 at the interface between the SiN film 35 and the fluorine-containing UV-ray-cured resin 12, as shown in FIG. 4D. In the second example, separation was achieved at the interface between the SiN film 35 formed on the micro pattern and the fluorine-containing UV-ray-cured resin 12, to obtain the inverted pattern, which is obtained by inverting the concavo-convex pattern formed on the molded SiO₂ 31, on the surface of Si substrate 34.

A third example will be described hereinafter. The third example uses the molded Ni as the first substrate on which the concavo-convex pattern was formed. A SiO₂ film was used as the dielectric film. A 1.2-mm-thick glass substrate was used as the transfer-target substrate. In the third example, the concavo-convex pattern formed on molded Ni was transferred onto the glass substrate.

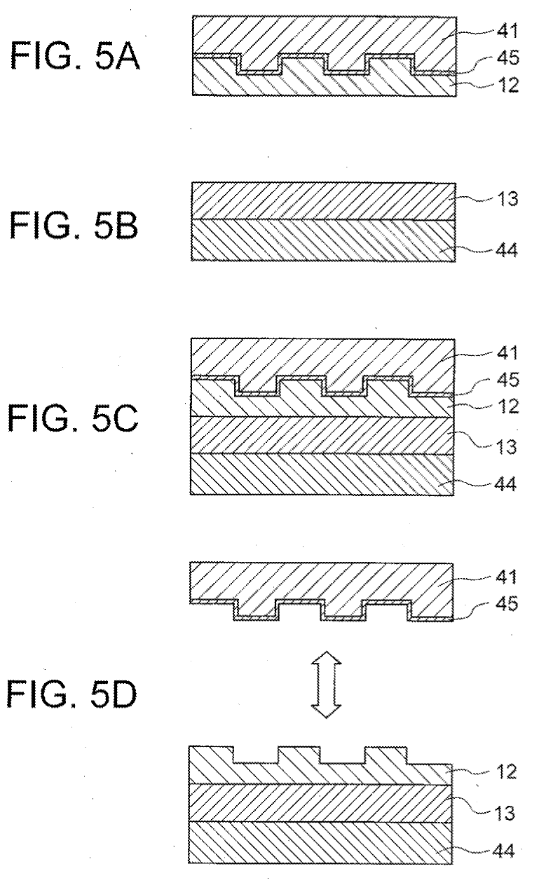

FIGS. 5A to 5D show consecutive steps of a process of the third example. The first substrate was a 350-μm-thick molded Ni 41 having the micro pattern on one of the surfaces thereof. A 20-nm-thick SiO₂ film 45 was formed on the surface of concavo-convex pattern on the molded Ni 41 by using a sputtering technique. The fluorine-containing UV-ray-cured resin 12 was applied for coating onto the surface of SiO₂ film 45, as shown in FIG. 5A. A photosensitive-cured resin similar to that used in the first example was used as the fluorine-containing UV-ray-cured resin 12 in this example.

Thereafter, the fluorine-free UV-ray-cured resin 13 was applied for coating onto the 1.2-mm-thick glass substrate 44, followed by irradiation of UV rays from the outside for preliminary curing of the fluorine-free UV-ray-cured resin 13 to obtain the structure shown in FIG. 5B. A photosensitive-cured resin similar to that used in the first example was used as the fluorine-free UV-ray-cured resin 13 in this example. Subsequently, the molded Ni 41 and glass substrate 44 were coupled and bonded together so that the fluorine-containing UV-ray-cured resin 12 and the fluorine-free UV-ray-cured resin 13 were in contact with each other. In this state, UV rays were irradiated from the outside through the glass substrate 44 for curing and bonding together the fluorine-containing UV-ray-cured resin 12 and fluorine-free UV-ray-cured resin 13, as shown in FIG. 5C.

Thereafter, the molded Ni 41 and glass substrate 44 were separated from each other at the interface between the SiO₂ film 45 and the fluorine-containing UV-ray-cured resin 12, as shown in FIG. 5D. In the third example, the separation was achieved at the interface between the SiO₂ film 45 formed on the micro pattern and the fluorine-containing UV-ray-cured resin 12, thereby forming on the glass substrate 44 the inverted pattern obtained by inverting the concavo-convex pattern formed on molded Ni 41.

For the purpose of comparison with the third example, a process of second comparative example was conducted wherein pattern was transferred without using the fluorine-free UV-ray-cured resin 13, i.e., adhesion reinforcing layer. The second comparative example used a molded Ni and a glass substrate similar to those used in the third example. The second comparative example included the steps of forming a 20-nm-thick SiO₂ film on the molded Ni, applying the fluorine-containing UV-ray-cured resin for coating onto the SiO₂ film, and coupling together the molded Ni and glass substrate without the step of applying the fluorine-free UV-ray-cured resin onto the fluorine-containing UV-ray-cured resin. The resultant structure was then subjected to irradiation of UV rays through the glass substrate for curing the fluorine-containing UV-ray-cured resin.

Thereafter, separation between the substrates was performed for transferring the pattern. The pattern transfer was succeeded by the separation only twice among the five experimental processes. The remaining three experimental processes were such that the separation proceeded at the interface between the glass substrate, i.e., transfer-target substrate and the fluorine-containing UV-ray-cured resin, whereby the desired pattern transfer was not obtained on the glass substrate in the second comparative example. The reason of this failure may have resulted from the fact that the fluorine-containing UV-ray-cured resin was in contact with the 20-nm-thick SiO₂ film on one side and with the glass substrate on the other side. In such a case, both the interfaces of the fluorine-containing UV-ray-cured resin have an equivalent adhesive strength, thereby reducing the reproducibility that the fluorine-containing UV-ray-cured resin adheres onto the glass substrate with a larger force.

A fourth example will be described hereinafter. The fourth example used, as the first substrate, a molded PC substrate having a micro pattern, similarly to the first example. An Al₂O₃ film was used as the dielectric film. The transfer-target substrate was a 100-μm-thick PC film, as in the first example. In the fourth example, the micro concavo-convex pattern formed on the molded PC substrate was transferred onto the PC film.

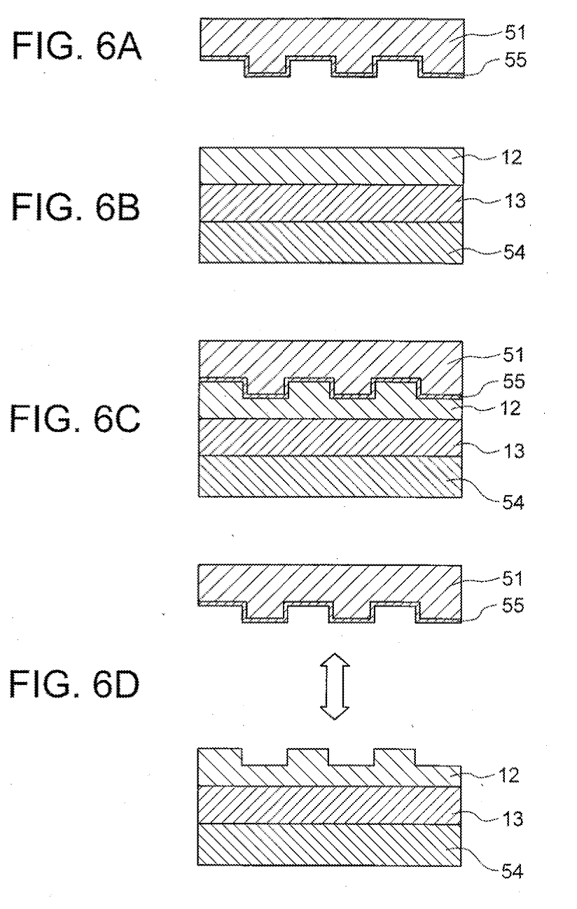

FIGS. 6A to 6D show consecutive steps of the process of the fourth example. A 20-nm-thick Al₂O₃ film was formed on the surface of concavo-convex pattern formed on the molded PC substrate 51 by using a sputtering technique, as shown in FIG. 6A. On the other hand, the fluorine-free UV-ray-cured resin 13 was applied for coating onto the PC film 54, followed by irradiation of UV rays onto the fluorine-free UV-ray-cured resin 13 for preliminary curing thereof. Subsequently, the fluorine-containing UV-ray-cured resin 12 was applied for coating onto the fluorine-free UV-ray-cured resin 13, as shown in FIG. 6B. Photosensitive cured resins similar to those used in the first example were used as the fluorine-containing UV-ray-cured resin 12 and fluorine-free UV-ray-cured resin 13 in this example.

Thereafter, the molded PC substrate 51 and the PC film 54 were coupled and bonded together so that the fluorine-free UV-ray-cured resin 12 and the Al₂O₃ film 55 were in contact with each other. UV rays were irradiated from the outside through the molded PC substrate 51 onto the fluorine-containing UV-ray-cured resin 12 and fluorine-free UV-ray-cured resin 13 for curing and bonding together, as shown in FIG. 6C. Subsequently, the molded PC substrate 51 and the PC film 54 were separated at the interface between the Al₂O, film 55 and the fluorine-containing UV-ray-cured resin 12, as shown in FIG. 6D. Thus, a PC film 54 having thereon an inverted pattern that is obtained by inverting the micro pattern formed on the molded PC substrate was obtained after the separation.

A fifth example will be described hereinafter. The fifth example used, as the first substrate, a molded PC substrate on which the concavo-convex pattern was formed on both surface thereof. A SiON film was used as the dielectric film. A pair of 100-μm-thick PC films were used as the transfer-target substrates. In the fourth example, the concavo-convex pattern formed on molded PC substrate was transferred onto two PC films at the same time.

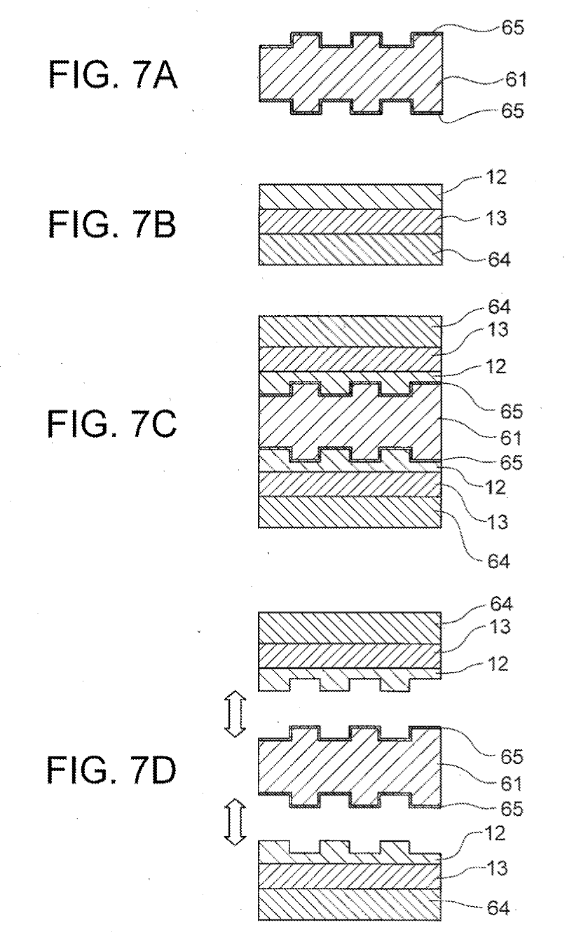

FIGS. 7A to 7D show consecutive steps of a process of the fifth example. A 20-nm-thick SiON film 65 was formed on the surface of concavo-convex pattern on the molded PC substrate 61 by using a sputtering technique, as shown in FIG. 7A. Subsequently, the fluorine-free UV-ray-cured resin 13 was applied for coating onto each of the PC films 64, followed by irradiation of UV rays from the outside for preliminary curing of the fluorine-free UV-ray-cured resin 13. Thereafter, the fluorine-containing UV-ray-cured resin 12 was applied for coating onto the fluorine-free UV-ray-cured resin 13, as shown in FIG. 7B. Photosensitive cured resins similar to those used in the first example were used as the fluorine-containing UV-ray-cured resin 12 and fluorine-free UV-ray-cured resin 13 in this example.

Thereafter, the molded PC substrate 61 and two PC films 64 were coupled and bonded together so that the SiON film 65 and the fluorine-containing UV-ray-cured resin 12 were in contact with each other. At this stage, the molded PC substrate 61, which had the micro pattern on both surfaces thereof, was sandwiched between the two PC films 64. In this state, UV rays were irradiated from the outside for curing and boding together the fluorine-containing UV-ray-cured resin 12 and fluorine-free UV-ray-cured resin 13, which were in contact with the SiON film 65 on both sides of the molded PC substrate 61, as shown in FIG. 7C.

Thereafter, the molded PC substrate 61 and two PC films 64 were separated from each other at the interface between the SiON film 65 and the fluorine-containing UV-ray-cured resin 12, as shown in FIG. 7D. In the fifth example, the separation was achieved at the interface between the SiON film 65 formed on the micro pattern and the fluorine-containing UV-ray-cured resin 12, thereby forming on the two PC substrates 64 the inverted pattern obtained by inverting the concavo-convex pattern formed on the molded PC substrate 61.

In the present embodiment, the configuration wherein the concavo-convex pattern is formed on both surfaces of the first substrate and pattern transfer is performed on both surfaces allows a single transferring process to form two micro patterns at the same time. Thus, the throughput of the pattern transfer is doubled.

In each of the above examples, the replica (inverted pattern) of a master disk or photomask is first formed, and then at least one dielectric film such as made of oxide, nitride or oxynitride is layered thereon. Thereafter, fluorine-containing UV-ray-cured resin having a superior releasability from those materials is applied for coating onto the surface of the dielectric film, followed by transferring the pattern onto the transfer-target substrate via the fluorine-free UV-ray-cured resin. This pattern transfer process provides a superior feasibility for the transfer of pattern from the master disk or stamper to a transfer-target substrate.

In each of the first through fifth example, a SiON film, SiN film, SiO₂ film, or Al₂O₃ film is formed in order to enhance the releasability of the fluorine-containing UV-ray-cured resin or to prevent a reaction between the surface of the fluorine-containing UV-ray-cured resin and the first substrate depending on the property of the first substrate. These dielectric films preferably have an extinction coefficient equal to or lower than 0.1. An extinction coefficient higher than 0.1 reduces the intensity of UV rays used for curing of the UV-ray-cured resin, thereby causing insufficient curing of the UV-ray-cured resin. The above value of extinction coefficient used in this text is for the wavelength range of the UV rays irradiated for the curing. The irradiation system used in the above examples is one that irradiated mixed UV rays each having a wavelength of 360 nm or shorter.

In the above examples, the substrates were bonded together after the application of UV-ray-cured resin. However, at least a part of the step of applying UV-ray-cured resin and at least a part of the step of bonding may be combined as a single step. For example, the process may include the step of applying a UV-ray-cured resin in an annular shape onto a substrate or another UV-ray-cured resin that is preliminarily cured, coupling two substrates with an intervention of the applied UV-ray-cured resin, and rotating the two substrates for expanding the applied UV-ray-cured resin to bond together both the substrates.

The bonding of the substrates may be performed in the atmosphere, or in a reduced-pressure ambient. In an alternative, the bonding may be first performed in the reduced-pressure ambient, and then exposed to the atmospheric pressure to thereby obtain a higher pressing force for the final bonding. It was confirmed that superior pattern transfer can be obtained in any case.

While the invention has been particularly shown and described with reference to exemplary embodiment thereof, the invention is not limited to these embodiments and modifications. As will be apparent to those of ordinary skill in the art, various changes may be made in the invention without departing from the spirit and scope of the invention as defined in the appended claims.

1. A method comprising:
forming a dielectric film on at least one of surfaces of a first substrate on which a concavo-convex pattern is formed;
coupling together said first substrate and a second substrate with an intervention of said dielectric film, a fluorine-containing ultraviolet (UV)-ray-cured resin and a fluorine-free UV-ray-cured resin which are arranged in this order from said first substrate to said second substrate; and
separating said first substrate from said second substrate at an interface between said dielectric film and said fluorine-containing UV-ray-cured resin, to transfer said concavo-convex pattern onto said fluorine-containing UV-ray-cured resin.

2. The method according to claim 1, wherein said coupling includes irradiating UV rays onto said fluorine-containing UV-ray-cured resin and/or said fluorine-free UV-ray-cured resin for curing the same.

3. The method according to claim 2, wherein said dielectric film includes at least one material selected from the group consisting of oxide, nitride and oxynitride having an extinction coefficient of 0.1 or lower with respect to a UV ray irradiated in said UV rays irradiating.

4. The method according to claim 1, wherein said dielectric film has a thickness of 5 to 25 nm.

5. The method according to claim 1, wherein said first substrate includes as a main component thereof polycarbonate (PC), silica glass, nickel or silicon.

6. The method according to claim 2, wherein said second substrate includes as a main component thereof polycarbonate (PC), glass or silicon.

7. The method according to claim 1, wherein said coupling comprises:
applying said fluorine-containing UV-ray-cured resin onto said dielectric film;
irradiating UV rays onto said fluorine-containing UV-ray-cured resin;
applying said fluorine-free UV-ray-cured resin onto said second substrate;
coupling together said first substrate and said second substrate so that said fluorine-containing UV-ray-cured resin and said fluorine-free UV-ray-cured resin are in contact with each other; and
irradiating UV rays onto said fluorine-containing UV-ray-cured resin and said fluorine-free UV-ray-cured resin that are in contact with each other.

8. The method according to claim 1, wherein said coupling comprises:
applying said fluorine-containing UV-ray-cured resin onto said dielectric film;
irradiating UV rays onto said fluorine-containing UV-ray-cured resin;
applying said fluorine-free UV-ray-cured resin onto said fluorine-containing UV-cured resin that is irradiated with said UV rays;
coupling together said first substrate and said second substrate so that said fluorine-free UV-ray-cured resin and said second substrate are in contact with each other; and
irradiating UV rays onto said fluorine-containing UV-ray-cured resin and said fluorine-free UV-ray-cured resin that is in contact said second substrate.

9. The method according to claim 1, wherein said coupling comprises:
applying a fluorine-free UV-ray-cured resin onto said second substrate;
irradiating UV rays onto said fluorine-free UV-ray-cured resin on said second substrate;
applying said fluorine-containing UV-ray-cured resin onto said dielectric film; and
coupling together said first substrate and said second substrate so that said fluorine-containing UV-ray-cured resin and said fluorine-free UV-ray-cured resin are in contact with each other; and
irradiating UV rays onto said fluorine-containing UV-ray-cured resin and said fluorine-free UV-ray-cured resin that is in contact said second substrate.

10. The method according to claim 1, wherein said coupling comprises:
applying said fluorine-free UV-ray-cured resin onto said second substrate;
to irradiating UV rays onto said fluorine-free UV-ray-cured resin on said second substrate;
applying said fluorine-containing UV-ray-cured resin onto said fluorine-free UV-ray-cured resin; and
coupling together said first substrate and said second substrate so that said fluorine-containing UV-ray-cured resin and said dielectric film are in contact with each other; and
irradiating UV rays onto said fluorine-containing UV-ray-cured resin and said fluorine-free UV-ray-cured resin that is in contact said second substrate.

11. A structure comprising thereon the micro pattern formed by using the method according to claim 1.
